(19) United States
(12) Patent Application Publication
(10) Pub. No.: US 2014/0360347 A1
(43) Pub. Date: Dec. 11, 2014

(54) HIGH DENSITY UNIDIRECTIONAL FABRIC FOR SOFT BALLISTICS APPLICATIONS

(71) Applicants: Teijin Armid B.V., 6824 BM Arnhem (NL); Barrday Inc., Cambridge (CA)

(72) Inventors: Jason van Heerden, Cambridge (CA); Jonathan MacNeil, York, SC (US); Chinkal Patel, Ancaster (CA); Matt Towery, Charlotte, NC (US); Jason Wilson, Huntersville, NC (US); Marc-Jan de Haas, Apeldoorn (NL)

(73) Assignee: Teijin Armid B.V., Arnhem (NL)

(21) Appl. No.: 14/372,537

(22) PCT Filed: Jan. 17, 2013
(86) PCT No.: PCT/US2013/021905

§ 371 Date: Jul. 16, 2014

Related U.S. Application Data
(60) Provisional application No. 61/587,310, filed on Jan. 17, 2012.

(51) Int. Cl. F41H 5/04; B32B 27/32; B32B 5/12

(52) U.S. Cl. CPC F41H 5/0478; B32B 5/12; B32B 27/32; F41H 5/0485; B32B 2250/02; B32B 2250/20; B32B 2250/24; B32B 2260/021; B32B 2260/046; B32B 2262/0269; B32B 2323/00; B32B 2571/02
USPC 89/36.02

(57) ABSTRACT

A ballistic article is comprised of high density fibers, where the linear mass density of the fibers is greater than 2000 dtex as measured by ASTM D1907 and the fibers in each layer have a total areal density greater than 100 g/m². In one example, the ballistic article has two sheets comprising para-aramid fibers in a styrene and isoprene block copolymer matrix material.

### CROSS-REFERENCE TO RELATED APPLICATIONS

This application claims priority to U.S. Provisional Application No. 61/587,310 which was filed on Jan. 17, 2012.

### FIELD OF THE INVENTION

This disclosure relates to ballistic resistant articles, especially high performance fiber and resin laminates for protective applications.

### BACKGROUND OF THE INVENTION

Multi-layer composites can be used for a number of applications, including for instance ballistic-resistant articles. Ballistic-resistant articles can be made from layers of woven or non-woven fabrics comprising fibers in a matrix material, or a combination thereof. Unidirectional (UD) fabrics, where the fibers are oriented in a single direction, can be used for ballistic articles.

### SUMMARY OF THE INVENTION

Disclosed is a ballistic article that has at least one sheet of unidirectional fabric. The unidirectional fabric includes fibers that have a linear mass density greater than 2000 dtex and a total areal density of the fibers in each sheet of the at least one sheet is greater than 100 g/m².

In another aspect, a ballistic article includes two sheets. Each sheet includes para-aramid fibers in a styrene-isoprene-styrene block copolymer matrix material. A linear mass density of the fibers is greater than 2000 dtex and an areal density of the fibers in each sheet is greater than 100 g/m². The article has a V₅₀ value for ballistic performance testing with .44 Magnum Speer bullets of greater than 500 m/s, and a V₅₀ value for ballistic performance testing with 9 mm Remington or .357 Magnum Remington bullets of greater than 430 m/s.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 shows a schematic example 2-ply unidirectional fabric construction.

FIG. 2 shows ballistic testing results for deforming projectiles for various unidirectional constructions.

### DETAILED DESCRIPTION OF THE INVENTION

Unidirectional (UD) constructions such as those used for ballistic resistant articles can have one or more layers, where each layer is comprised of fibers oriented in a single direction and impregnated with a matrix material. When the UD layers are formed, the fibers are spread to ensure even fiber and filament distribution throughout the material.

During formation of UD layers, vibration can be used to spread the fibers or filaments evenly. For example, the fibers or filaments can be passed over a spreader unit that includes at least one bar and at least one vibration unit along the length of the bar. The vibration unit can vibrate the bar horizontally, vertically, or a combination of the two directions with respect to the fiber length. Use of a vibrating bar can allow for improved spreading of denser fibers. The vibration unit can be pneumatic, electro-magnetic, or another type of vibrating unit. The bar can be mounted at the edges using a non-rigid mount such as a rubber mount to allow for better vibration.

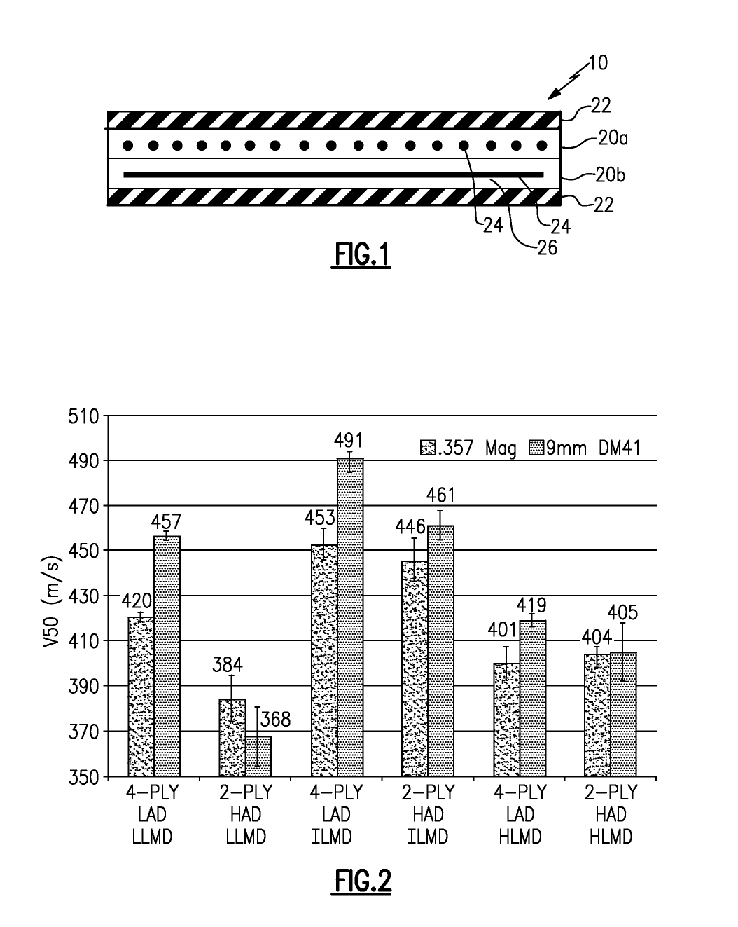

FIG. 1 shows an example 2-ply UD construction with plies 20a, 20b. Plies 20a and 20b have fiber orientations offset from one another by 90°. Each ply comprises fibers 24 in a matrix material 26. Cross-plying can be achieved by application of heat and pressure to ensure proper adhesion of the plies to one another. UD constructions can also have films 22 laminated on the outer surfaces. Lamination can be performed by a belt laminator, which applies heat and pressure to ensure proper adhesion of the film. For soft-armor ballistics applications, 2-ply 0°/90° or 4-ply 0°/90°/0°/90° UD constructions can be used, where “0°/90° ” represents two stacked plies of UD sheets with fiber orientations 90° offset from one another For example, the UD construction 10 of FIG. 1 would be a 2-ply 0°/90° construction.

Forming UD layers with low fiber areal density, for example, with areal density less than 50 g/m², requires more control over the fiber spreading processes during production. Control of the spreading process is less important for the production of thicker UD monolayers. Furthermore, to achieve a desired UD-based ballistic construction weight, which is typically 1.0 lbs/ft² (4.8 kg/m²), the number of UD monolayers needed for the construction increases if the fibers have low areal density. An increased number of UD monolayers necessitates additional manufacturing steps and incurs additional manufacturing costs. Additionally, yarns with higher linear densities can be less expensive and absorb less water than yarns with lower linear densities.

A surprising ballistic benefit for deforming projectiles was discovered with the use of high areal density unidirectional (UD) constructions. In one example, UD constructions can be fabricated from para-aramid fibers, such as those available under the trade name Twaron®, and the resin matrix can be a copolymer resin such as that available under the trade name Prinlin HV (e.g. Prinlin B7137 HV). In another example, the UD construction can be coated with a polyethylene (PE) film.

UD constructions comprising yarns with low linear mass densities perform better in ballistic testing when the overall UD construction has a low areal density. However, it has now been discovered that certain UD constructions with fibers of high linear mass densities, for example, where the linear mass density of the fibers is greater than 2000 dtex, or alternatively greater than 3000 dtex, as measured by ASTM D1907, with the areal density of the fibers being greater than 100 g/m², perform comparably to or exceed the ballistic performance of low areal density constructions. The areal density represents the dry fiber weight per unit area, and the linear mass density represents the dry fiber weight per unit length.

In one example, a high areal density (HAD) UD fabric was constructed with a 0° direction total, fiber-only, areal density of 104 g/m². The HAD UD included type 1000 (T1000) Twaron® fibers with a linear mass density of 3360 dtex and a Prinlin B7137 HV matrix at 17% dry resin content. Dry resin content is determined using the equation: dry resin content=(dry resin weight/(dry fiber weight+dry resin weight))×100%. The material properties of T1000 fibers are shown in Table 1 below. These material properties, including fiber tenacity, fiber modulus and elongation at break, are measured according to ASTM D7269-07. The final UD construction was a 2-ply product with orientation F/0°/90°/F, where “F” indicates a film layer and “0°/90° ” represents two stacked plies of UD sheets with fiber orientations 90° offset from one another. The stacked plies were cross-plied at temperatures of 80 to 100° C. with pressure less than 2 bar while belt lamination was completed in a two-step process. The first step was performed at pressures below 5 bar with elevated temperatures of 120 to 150° C. and the second step was at temperatures of 80 to 100° C., also below 5 bar. The UD construction had a 0.25 to 0.35 mil (6.4 to 8.9 μm) PE film on the outer layers applied during the belt lamination process. The PE film can be a traditional blown film, such as a low-density polyethylene (LDPE) or linear low-density polyethylene (LLDPE) film, or it can be a machine direction oriented (MDO) film. In this example, a 0.25 mil (6.4 μm) thick LLDPE film supplied by Raven Industries (Sioux Falls, S.Dak.) as N0.25C, is used. The total density of the final 2-ply product was 254.4 g/m².

This HAD UD construction was compared to a low areal density (LAD) construction comprising the same T1000 3360 dtex Twaron® fibers. The LAD UD construction was a 4-ply product with orientation F/0°/90°/0°/90°/F and 0° direction total, fiber-only, areal density of 48 g/m² and a Prinlin B7137 HV matrix at 17% dry resin content.

A second LAD construction comprising type 2000 (T2000) 1100 dtex Twaron® fibers was also tested. T2000 fibers have different material properties, including the fiber tenacity, modulus and elongation at break, as is shown in Table 1. Table 1 also shows the results of ballistic testing of the HAD and LAD UD constructions. Ballistic tests were performed using deformable .44 caliber Magnum Speer bullets (Speer Bullets, Lewiston, Ind.). The V₅₀ value of the construction is indicative of ballistic performance and evaluated according to MIL-STD 662F.

TABLE 1
Ballistic Testing Results for HAD and LAD UD Constructions With .44 Magnum Speer Bullets

| | Fiber | Fiber | Elongation | 0° Direction | | | | V₅₀ ± |
|---|---|---|---|---|---|---|---|---|
| Fiber | Tenacity | Modulus | at Break | Areal Density | Final Product | Final Product | Shoot Pack | STD |
| Type | [mN/tex] | [GPa] | [%] | (fiber only) | Configuration | Weight (g/m²) | Weight (psf) | [m/s] |
| HAD UD, | 2032 | 66 | 3.7 | 104 g/m² | F/0°/90°/F | 254.4 | 1.18 | 509 ± 18 |
| T1000 | | | | | | | | |
| 3360dtex | | | | | | | | |
| LAD UD, | 2032 | 66 | 3.7 | 48 g/m² | F/0°/90°/0°/90°/F | 240.1 | 1.22 | 457 ± 8 |
| T1000 | | | | | | | | |
| 3360dtex | | | | | | | | |
| LAD UD, | 2350 | 91 | 3.5 | 47 g/m² | F/0°/90°/0°/90°/F | 230.8 | 1.22 | 498 ± 4 |
| T2000 | | | | | | | | |
| 1100dtex | | | | | | | | |

The HAD UD construction showed a 15% increase in ballistic performance with .44 Magnum Speer bullets when compared to on the 3360 dtex LAD UD construction on a weight per weight basis of shoot pack. Furthermore, in this example the ballistic performance of the HAD UD with the low tenacity yarns (HAD T1000 3360 dtex) was better or at least comparable to the LAD UD product using the high tenacity yarn (LAD T2000 1100 dtex). This is advantageous because fewer plies of HAD UD material are needed to achieve ballistic performance comparable to the LAD UD material and because low tenacity yarns are generally less expensive than high tenacity yarns. Manufacturing complexity and production costs can therefore be reduced.

Similar ballistic tests were performed on the same three UD constructions using non-deformable caliber 9 mm bullets and .357 Magnum bullets (Remington Arms Company, Inc., Madison, N.C.). Results from these ballistic tests are given in Tables 2 and 3, respectively.

TABLE 2
Ballistic Testing Results for HAD and LAD UD Constructions with 9 mm
Remington Bullet

| | Fiber | 0° Direction | | | |
|---|---|---|---|---|---|
| Fiber | Tenacity | Areal Density | Final Product | Shoot Pack | V₅₀ ± STD |
| Type | [mN/tex] | (fiber only) | Configuration | Weight (psf) | [m/s] |
| HAD UD, | 2032 | 104 g/m² | F/0°/90°/F | 0.75 | 441 ± 8 |
| T1000 | | | | | |
| 3360dtex | | | | | |
| LAD UD, | 2032 | 48 g/m² | F/0°/90°/0°/90°/F | 0.76 | 422 ± 6 |
| T1000 | | | | | |
| 3360dtex | | | | | |
| LAD UD, | 2350 | 47 g/m² | F/0°/90°/0°/90°/F | 0.78 | 507 ± 6 |
| T2000 | | | | | |
| 1100dtex | | | | | |

TABLE 3
Ballistic Testing Results for HAD and LAD UD Constructions with.357 Magnum
Remington Bullet

| | Fiber | 0° Direction | | | |
|---|---|---|---|---|---|
| Fiber | Tenacity | Areal Density | Final Product | Shoot Pack | V₅₀ ± STD |
| Type | [mN/tex] | (fiber only) | Configuration | Weight (psf) | [m/s] |
| HAD UD, | 2032 | 104 g/m² | F/0°/90°/F | 0.69 | 442 ± 3.2 |
| T1000 | | | | | |
| 3360dtex | | | | | |
| LAD UD, | 2032 | 48 g/m² | F/0°/90°/0°/90°/F | 0.71 | 422 ± 2 |
| T1000 | | | | | |
| 3360dtex | | | | | |
| LAD UD, | 2350 | 47 g/m² | F/0°/90°/0°/90°/F | 0.74 | 471 ± 1.5 |
| T2000 | | | | | |
| 1100dtex | | | | | |

The low tenacity T1000 HAD construction performed better than the low tenacity T1000 LAD construction and approached the performance of the T2000 LAD fibers. As is shown in Table 1, T1000 fibers have a tenacity of 2032 mN/tex , whereas T2000 fibers have a tenacity of 2350 mN/tex, from which better nominal ballistic performance can be expected.

Additionally, the HAD UD constructions comprising T1000 3360 dtex fibers and LAD UD constructions comprising T2000 1100 dtex fabricated as described above were tested for water absorption. Testing panels were formed by cutting layers of 400×400 mm, followed by stacking 15 layers and stitching the panels at the corners. For the HAD UD the layer configuration was F/0°/90°/F, and for the LAD UD the layer configuration was F/0°/90°/0°/90°/F. The dry weight of the panels was recorded before submersion in water and is given in Table 4. Panels were submerged for 10 or 60 minutes. Panels were then removed from water and, after draining dry for 3 minutes, the wet weight of the panels was determined and is given in Table 4. The weight increase is therefore a measure for the degree of water absorption. Water absorption for panels made from HAD UD is significantly lower than that of panels made from LAD UD.

TABLE 4
Water Absorption of HAD and LAD UD Constructions

| | Time in | Dry | Wet | Weight |
|---|---|---|---|---|
| Fiber Type | Water (min) | Weight (g) | Weight (g) | Increase (%) |
| HAD UD, T1000 | 10 | 623 | 729 | 17.0 |
| 3360dtex | | | | |
| HAD UD, T1000 | 60 | 627 | 793 | 26.5 |
| 3360dtex | | | | |
| LAD UD, T2000 | 10 | 576 | 796 | 33.0 |
| 1100dtex | | | | |
| LAD UD, T2000 | 60 | 577 | 815 | 41.2 |
| 1100dtex | | | | |

In another example, 2-ply HAD and 4-ply LAD UD constructions were fabricated using T1000 Twaron® fibers with a low linear mass density (LLMD) of 1680 dtex and impregnated with a Prinlin B7137 HV matrix Similar 2-ply HAD and 4-ply LAD UD constructions were fabricated using T1000 Twaron® fibers with a high linear mass density, (HLMD) for example, with linear mass density of greater than 2000 dtex. In one example, the linear mass density of the HLMD fibers is greater than 3000 dtex. In the particular example tested, the linear mass density of the HLMD fibers was 3360 dtex. Similar 2-ply HAD and 4-ply LAD UD constructions were also fabricated using T2000 Twaron® fibers with an intermediate linear mass density (ILMD) of 2200 dtex. Here, the 2-ply constructions consisted of 2 UD layers in the F/0°/90°/F configuration where each layer had a fiber areal density of 104 g/m² and the 4-ply constructions consisted of 4 UD layers in the F/0°/90°/0°/90°/F configuration where each layer had a fiber areal density of 47 g/m². In both the 2-ply and the 4-ply constructions, a Prinlin B7137 HV matrix at 17% dry resin content was present and a 6.4 μm thick LLDPE film supplied by Raven Industries (Sioux Falls, S.Dak.) as N025C, was used. Ballistic testing with .357 Mag (Remington Arms Company, Inc., Madison, N.C.,) and 9 mm DM41 projectiles (RUAG Ammotec AG, Switzerland), was performed on the six UD constructions. Test panels with 4-ply LAD UD constructions for .357 Mag projectiles were made by cutting layers of 400×400 mm followed by stacking 15 layers and stitching the panels at the corners. Test panels with 2-ply HAD UD constructions for .357 Mag projectiles were made by cutting layers of 400×400 mm followed by stacking 13 layers and stitching the panels at the corners. Test panels with 4-ply LAD UD constructions for 9 mm DM41 projectiles were made by cutting layers of 400×400 mm followed by stacking 19 layers and stitching the panels at the corners. Test panels with 2-ply HAD UD constructions for 9 mm DM41 projectiles were made by cutting layers of 400×400 mm followed by stacking 16 layers and stitching the panels at the corners.

FIG. 2 shows the V₅₀ values for each of the six UD constructions for both projectile types. As is clear from FIG. 2, there is a substantial reduction in the V₅₀ value for both .357 Mag and 9 mm DM41 projectiles going from 4-ply LAD UD to 2-ply HAD UD in the case of LLMD. However, the 2- and 4-ply HLMD UD constructions performed essentially the same. Similarly, for the .357 Mag projectiles, the V₅₀ values for 2-ply and 4-ply ILMD UD constructions were essentially the same. For 9 mm DM41 projectiles, the V₅₀ value for the 4-ply ILMD UD construction was slightly higher than that for the 2-ply ILMD UD construction.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A ballistic article comprising:
at least one sheet comprising fibers in a polymeric matrix material, wherein the fibers have a linear mass density greater than 2000 dtex as measured by ASTM D1907 and the fibers in each sheet of the at least one sheet have a total areal density greater than 100 g/m².

2. The ballistic article of claim 1, wherein the linear mass density is greater than 3000 dtex as measured by ASTM D1907.

3. The ballistic article of claim 1, wherein the fibers are para-aramid fibers.

4. The ballistic article of claim 1, wherein the matrix is a block copolymer of styrene and isoprene.

5. The ballistic article of claim 1, wherein the at least one sheet has between 15 and 20% by weight of polymeric matrix material.

6. The ballistic article of claim 1, wherein the at least one sheet comprises multiple sheets, wherein each sheet has a fiber orientation offset by 90° from the fiber orientation of the immediately adjacent layers.

7. The ballistic article of claim 1, further comprising a polymeric film disposed on at least one outer surface of the article.

8. The ballistic article of claim 7, wherein the polymeric film is a polyethylene film.

9. The ballistic article of claim 1, wherein the fibers have a tenacity of between 1850 and 2500 mN/tex as measured according to ASTM D7269-07.

10. The ballistic article of claim 9, wherein the fibers have a tenacity of between 1850 and 2200 mN/tex as measured according to ASTM D7269-07.

11. The ballistic article of claim 9, wherein the fibers have a tenacity of between 2200 and 2500 mN/tex as measured according to ASTM D7269-07.

12. The ballistic article of claim 1, wherein the fibers have a modulus between 60 and 100 GPa as measured according to ASTM D7269-07.

13. The ballistic article of claim 12, wherein the fibers have a modulus between 60 and 80 GP as measured according to ASTM D7269-07.

14. The ballistic article of claim 12, wherein the fibers have a modulus between 80 and 100 GPa as measured according to ASTM D7269-07.

15. The ballistic article of claim 1, wherein the at least one sheet comprises two sheets, and the ballistic article has a V₅₀ value for ballistic performance testing with .44 Magnum Speer bullets of greater than 500 m/s as measured according to MIL-STD 662F, and a V₅₀ value for ballistic performance testing with 9 mm or .357 Magnum Remington bullets of greater than 430 m/s as measured according to MIL-STD 662F.

16. The ballistic article of claim 1, wherein the at least one sheet comprises two sheets, and wherein the percent weight increase of the article after submersion in water for 10 minutes is less than 20%, and the percent weight increase of the article after submersion in water for 60 minutes is less than 30%.

17. A ballistic article comprising:
two sheets, each comprising para-aramid fibers in a styrene and isoprene block copolymer matrix material, wherein the fibers in each sheet have a linear mass density greater than 2000 dtex as measured by ASTM D 1907 and the fibers in each sheet have a total areal density greater than 100 g/m², and wherein a V₅₀ value for ballistic performance testing with a .44 Magnum Speer bullet is greater than 500 m/s as measured according to MIL-STD 662F, and a V₅₀ value for ballistic performance testing with 9 mm or .357 Magnum Remington bullets is greater than 430 m/s as measured according to MIL-STD 662F.

18. The ballistic article of claim 17, further comprising a polyethylene film on at least one outer surface of the article.

19. The ballistic article of claim 17, wherein the fibers have a tenacity between 1850 and 2500 mN/tex as measured according to ASTM D7269-07.

20. The ballistic article of claim 17, wherein the fibers have a modulus between 60 and 100 GPa as measured according to ASTM D7269-07.
